(19) United States
(12) Patent Application Publication
(10) Pub. No.: US 2023/0119401 A1
(43) Pub. Date: Apr. 20, 2023

(54) SYSTEM AND METHOD FOR SUN VISOR ATTACHMENT

(71) Applicant: Tyrone M. Williams, Baltimore, MD (US)

(72) Inventor: Tyrone M. Williams, Baltimore, MD (US)

(21) Appl. No.: 17/965,331

(22) Filed: Oct. 13, 2022

Related U.S. Application Data
(60) Provisional application No. 63/255,789, filed on Oct. 14, 2021.

(51) Int. Cl. B60J 3/02

(52) U.S. Cl. CPC B60J 3/0208

(57) ABSTRACT

A sun visor attachment with interchangeable screens that may be pulled down whereby the sun visor attachment includes a framework having a plurality of receiving elements defining an opening into which the screens may be inserted whereby each receiving element may define a portion of a coplanar slot extending along the sun visor attachment, whereby one of the plurality of screens may be slidably received or removed in the resulting coplanar slot thereby providing a variety of interchangeable screens that may be extended out from the base of the sun visor attachment.

### CROSS REFERENCE TO RELATED APPLICATIONS

This application claims priority to U.S. Provisional Patent No. 63/255,789 filed on Oct. 14, 2021 which is incorporated in its entirety.

### FIELD OF THE DISCLOSURE

The present invention relates to a motor vehicle sun visor and more specifically to a sun visor having a series of panels extending below the manufacturer's opaque visor for the purposes of blocking headlights or sun light on a need to be basis.

### BACKGROUND

The U.S. Department of Transportation's Federal Highway Administration states the average person drives around 13,500 miles every year with most of the time during daylight. The sun visor is a component of an automobile designed with a hinged flap that is adjustable to help shade the eyes of drivers and passengers from the glare of sunlight. The standard sun visor shields some light but the constant repositioning is an inconvenience. Further, adjusting a visor while driving can be a dangerous distraction that takes your mind off of the road action. Often while driving when the sun is low in the sky, the position of the sun relative to the vehicle changes from the front window to the side window, requiring continuous adjustment of the sun visor to block the blinding rays of the sun. Repositioning the sun visor while driving is distracting and can be a danger to the driver and passengers. There are existing sun visor attachments that extend the length of the visor but do not accommodate for various situations such as needing to see through the visor at night or during the day. Thus exists the need for an improved sun visor attachment.

### SUMMARY

Broadly, an embodiment of the present invention may include a sun visor attachment with interchangeable screens that may be pulled down. The sun visor attachment includes a framework having a plurality of receiving elements defining an opening into which the screens may be inserted. Each receiving element may define a portion of a coplanar slot extending along the sun visor attachment, wherein one of the plurality of screens may be slidably received or removed in the resulting coplanar slot thereby providing a variety of interchangeable screens that may be extended out from the base of the sun visor attachment.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of an embodiment of a vehicle with the sun visor attachment in accordance with the present invention.

FIG. 2 is another view of the sun visor attachment.

FIG. 3 is another view of the sun visor attachment.

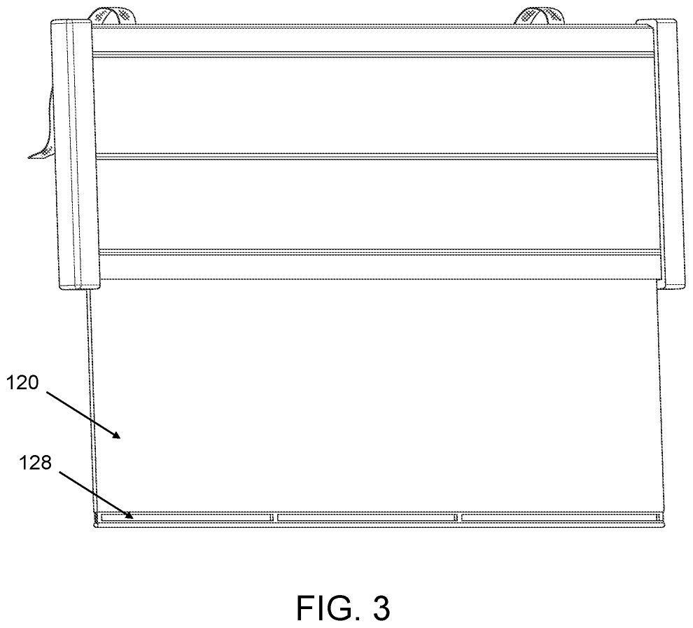

FIG. 4 is another view of the sun visor attachment.

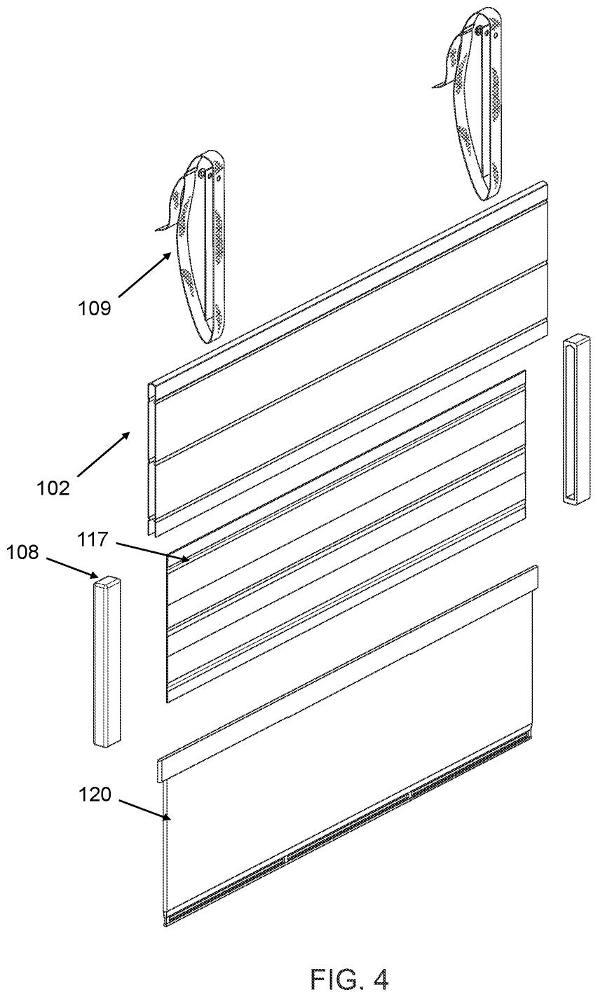

FIG. 5 is a view of the different lenses of the sun visor attachment.

FIG. 6 is a block diagram of the remote computing device.

FIG. 7 is a block diagram of a connected network for the sun visor attachment.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

Broadly, an embodiment of the present invention may include a sun visor attachment with interchangeable screens that may be pulled down. The sun visor attachment includes a framework having a plurality of receiving elements defining an opening into which the screens may be inserted. Each receiving element may define a portion of a coplanar slot extending along the sun visor attachment, wherein one of the plurality of screens may be slidably received or removed in the resulting coplanar slot thereby providing a variety of interchangeable screens that may be extended out from the base of the sun visor attachment.

The sun visor attachment may be positioned inside of an automobile in conjunction with a conventional left sun visor or right sun visor. The automobile may have mounting means for attaching the sun visors to the roof of the automobile. The sun visors may have a rod which runs through a longitudinal bore formed in the upper sun visor upper edge which will accept the rod. The sun visor may have a flat rectangular shape that is rotatable around the rod in order to allow the driver of the automobile to block sunlight rays from the eyes of the driver. The sun visor attachment acts as a secondary or auxiliary device that is fastened to the sun visor by any number of fasteners such as hinges, latches, adhesive or any other means which allows the sun visor attachment to be positioned on and fastened to either side of the sun visor when the sun visor is extended downward. In further non-limiting embodiments, sun visor attachments may be attached to any point of the vehicle including the front, side, and rear windows by one or more suction cups.

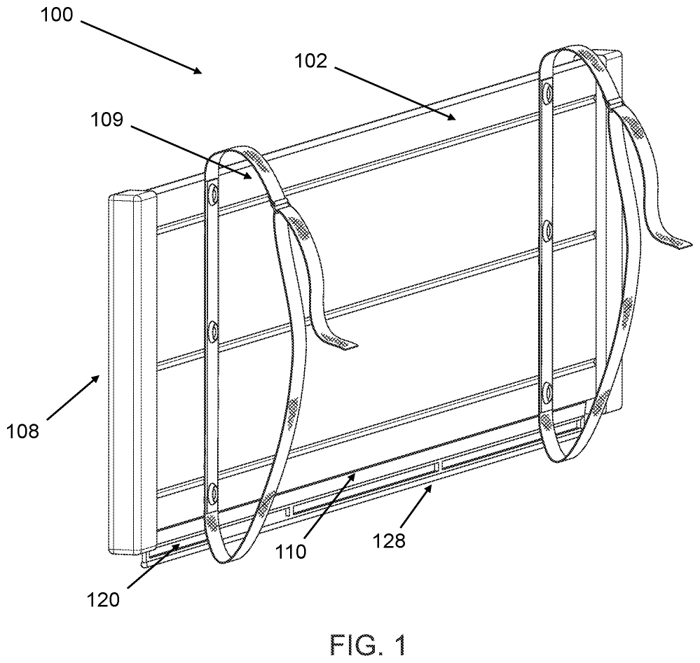

One embodiment of sun visor attachment 100 is illustrated in FIG. 1. Sun visor attachment 100 may have a housing 102 that is rectangular prism in shape. The housing has an open bottom surface, a closed top surface, and a plurality of open side surfaces connecting the bottom surface and the top surface. Sun visor attachment 100 may have a series of rectangular-shaped apertures positioned at the bottom surface allowing for one or more lenses or screens to extend downward through the apertures to provide a plurality of benefits to the driver while operating a vehicle.

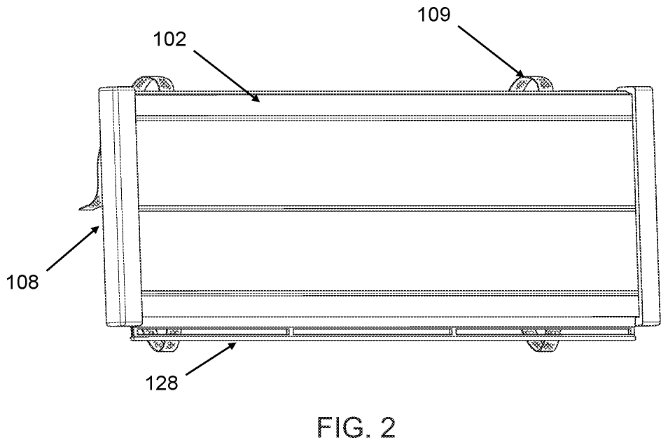

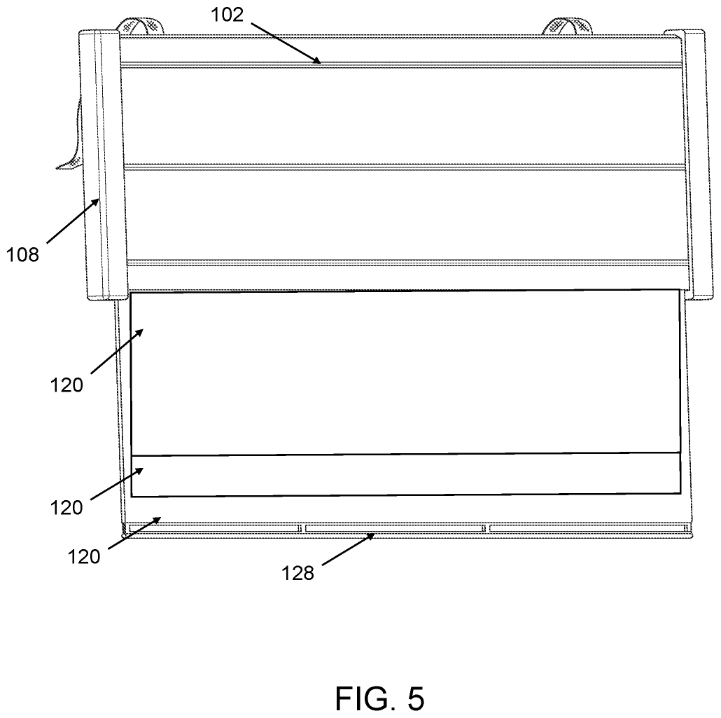

Sun visor attachment 100 may have a series of end caps 108 with guiding slots 110, as illustrated in FIG. 2, in communication with the apertures positioned at the bottom surface whereby end caps 108 are positioned onto and over the sides of housing 102. Guiding slots 110 may each have a support surface positioned inside of guiding slots 110 that is slidable along guiding slots 110 in an upward or downward motion. The supporting surface may have one or more receiving elements allowing for lenses 120, as illustrated in FIG. 5, to be mounted to the supporting surface such that when the supporting surface moves downward or upward in guiding slots 110, lenses 120 will move in unison with the supporting surface. One or more springs may be positioned inside guiding slots 110. The springs may have a lower end secured to the support surface while an upper end of the springs are anchored to a top surface of the guiding slots 110. The springs urge the support surface and lenses 120 upward into a storage position. One or more fillers or foams pieces 117 may be placed on both sides of slots 110 to protect the faces of lenses 120 from housing 102 while inside of slots 110 and help guide lenses 120. Lenses may have one or more protrusions extending outward such that lenses 120 may not completely leave housing 102.

In one or more non-limiting embodiments, a lever or knob may be positioned on the outside of the housing of sun visor attachment 100 and connected to the support surface. The lever may be moved downward against the action of the spring to move the support surface and lenses 120 into an active position whereby lenses 120 extends past the sun visor. Lenses 120 may be held in an active position by means of a latch member on the supporting surface with a hooked end adapted to engage a cooperating latch member extending from sun visor attachment 100. In other embodiments lenses 120 may partially extend outward already such that a user may pull them down in a vertical motion whereby lenses 120 have a plurality of handles 128 at a bottom of lenses 120 for user to pull down upon.

Adjacent to the latch member may be a latch tripping member controlled by a ratchet and pawl device that is arranged to engage an extending lug or other object on the latch member. A leaf spring may be secured to sun visor attachment 100 and has projecting members arranged to resistingly engage one or more members that urge toward a latching position. Whenever it is desired to trip the latch manually, the lever may be depressed, thereby rocking the latch member to release the supporting surface, permitting the spring to remove the supporting surface and lenses 120 from an active position.

As illustrated in FIG. 5, there may be four lenses 120 which extend downward past the sun visor. However, this is non-limiting and there may be any number of lenses providing different advantages. In this embodiment, lenses 120 may be color coded signifying the benefit provided by lenses 120. For instance, the first lens 120 may be purple or black which will block total glare from the sun, reduce temperature, and protect vision. A second lens 120 may be orange and provide a protected polarized see through lens for night, day, snow, or fog. A third lens 120 may provide a protected polarized see through lens for daytime similar to sunglasses minus the UV.

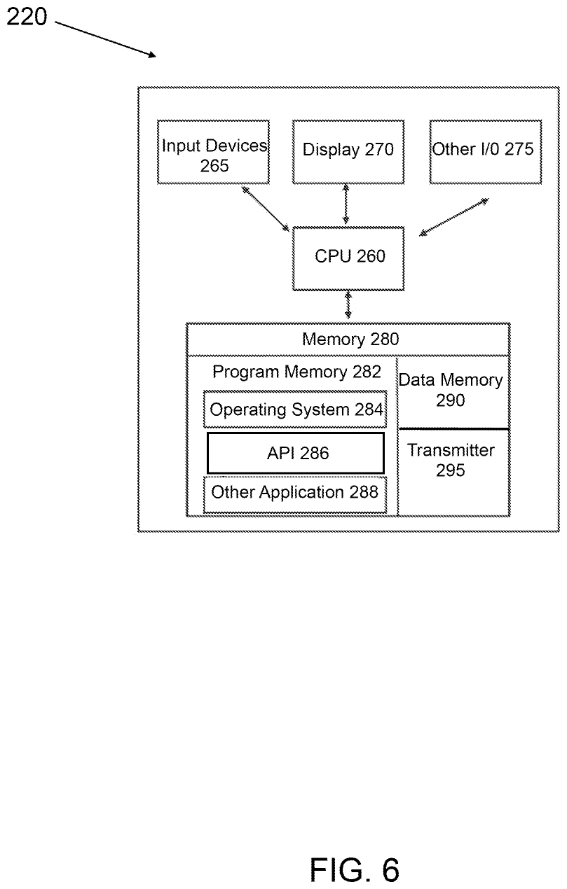

In further embodiments, sun visor attachment 100 may have an automatic electromechanical release mechanism 130 used to move the one or more lenses 120, as illustrated in FIG. 6. Electromechanical release mechanism 130 may utilize a control system for remote activation of the release mechanism. The release mechanism may have an electric motor which is mechanically engaged to a translatable supporting surface by a pulley system, operatively engaged reduction gears, or other methods known by those of ordinary skill in the art. The activation of a switch then powers the motor translating the support surface and lens along the track.

The control system may operate to control the actuation of the other systems including the release mechanism. The control system may have a series of computing devices. The control system may be in the form of a circuit board, a memory, or other non-transient storage medium in which computer-readable coded instructions are stored and one or more processors configured to execute the instructions stored in the memory. The control system may have a wireless transmitter, a wireless receiver, and a related computer process executing on the processors.

Computing devices of the control system may be any type of computing device that typically operates under the control of one or more operating systems which control scheduling of tasks and access to system resources. Computing devices may be any computing device capable of executing instructions with sufficient processor power and memory capacity to perform operations of the control system.

The one or more computing devices may be integrated into the control system, while in other non-limiting embodiments, the control system may be a remotely located computing device or server configured to communicate with one or more other control systems. The control system may also include an internet connection, network connection, and/or other wired or wireless means of communication (e.g., LAN, etc.) to interact with other components. The connection allows a user to update, control, send/retrieve information, monitor, or otherwise interact passively or actively with the control system.

The control system may include control circuitry and one or more microprocessors or controllers acting as a servo control mechanism capable of receiving input from sensors and other components, analyzing the input from sensors and other components, and generating an output signal to components. The microprocessors (not shown) may have on-board memory to control the power that is applied to the various systems. The control system may be preprogrammed with any reference values by any combination of hardwiring, software, or firmware to implement various operational modes including but not limited to temperature, light, and humidity values.

The microprocessors in the control system may also monitor the current state of circuitry within the control system to determine the specific mode of operation chosen by the user. Further, such microprocessors that may be part of the control system may receive signals from any of or all systems. Such systems may be notified whether any of the components in the various systems need to be replaced.

Electromechanical release mechanism 130 may include a wireless communication interface, which may be a digital, analog, or mixed-signal circuit to transmit wireless signals indicating user input received from electromechanical release mechanism 130. The wireless signals may be transmitted to a computing device 220 such as a phone, a computer, a wearable device, tablet, a virtual reality system, etc. The wireless communication interface may send and receive data via a wireless network without the need for connecting cables to sun visor attachment 100.

Turning to FIG. 6, FIG. 6 is a block diagram showing various components of computing device 220. Computing device 220 may comprise a housing for containing one or more hardware components that allow access to edit and query electromechanical release mechanism 130. Computing device 220 may include one or more input devices such as input devices 265 that provide input to a CPU (processor) such as CPU 260 of actions related to the user. Input devices 265 may be implemented as a keyboard, a touchscreen, a mouse, via voice activation, wearable input device, a 3D camera, a trackball, a microphone, a fingerprint reader, an infrared port, a controller, a remote control, a fax machine, and combinations thereof.

Actions may be initiated by a hardware controller that interprets the signals received from input device 265 and communicates the information to CPU 260 using a communication protocol. CPU 260 may be a single processing unit or multiple processing units in a device or distributed across multiple devices. CPU 260 may be coupled to other hardware devices, such as one or more memory devices with the use of a bus, such as a PCI bus or SCSI bus. CPU 260 may communicate with a hardware controller for devices, such as for a display 270. Display 270 may be used to display text and graphics. In some examples, display 270 provides graphical and textual visual feedback to a user.

In one or more embodiments, display 270 may include an input device 265 as part of display 270, such as when input device 265 is a touchscreen or is equipped with an eye direction monitoring system. In some implementations, display 270 is separate from input device 265. Examples of display 270 include but are not limited to: an LCD display screen or an LED.

Other I/O devices such as I/O devices 275 may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display 270 may be used as an output device, such as, but not limited to, a computer monitor, a speaker, a television, a smart phone, a fax machine, a printer, or combinations thereof.

CPU 260 may have access to a memory such as memory 280. Memory 280 may include one or more of various hardware devices for volatile and non-volatile storage and may include both read-only and writable memory. For example, memory 280 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application and application programing interface (API), such as application 286, and other computerized programs or application programs such as application programs 288. Memory 280 may also include data memory such as data memory 290 that may include database query results, configuration data, settings, user options, user preferences, or other types of data, which may be provided to program memory 282 or any element of user computing device 220.

Computing device 220 may have a transmitter, such as transmitter 295. Transmitter 295 may have a wired or wireless connection and may comprise a multi-band cellular transmitter to connect to the server over 2G/3G/4G/5G cellular networks. Other embodiments may also utilize Near Field Communication (NFC), Bluetooth, or another method to communicate information.

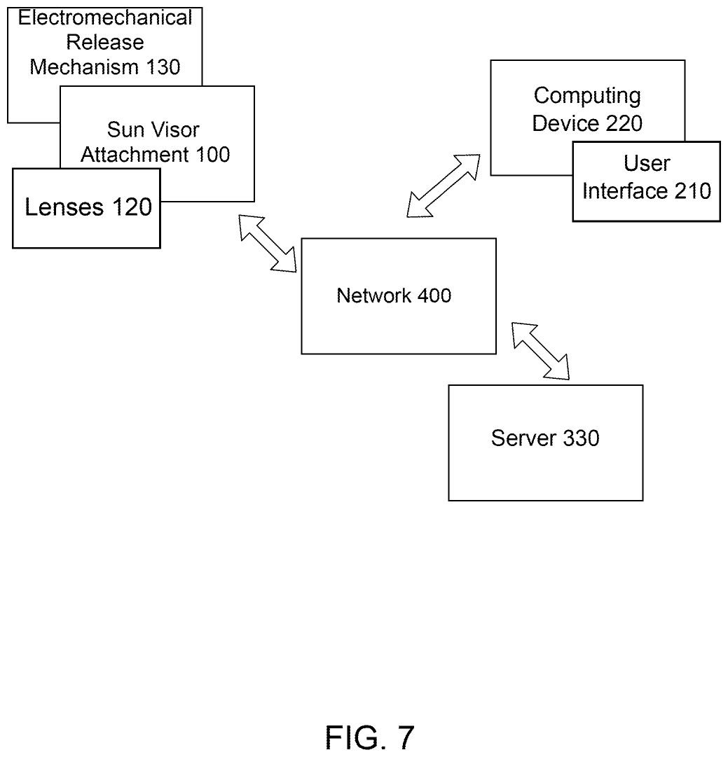

As illustrated in FIG. 7, a user may access a user interface, such as user interface 210 using computing device 220. User interface 210 may have a plurality of buttons or icons that are selectable to perform particular processes in response to the selections. User interface 210 may have conventional GUI interface devices such as a title bar, toolbars, pull-down menus, tabs, scroll bars, context help, dialog boxes, operating buttons (icons) and status bar the user 202 navigates throughout the display.

In some embodiments, sun visor attachment 100 and computing device 220 may be in communication with one or more servers, such as server 330 or one or more networks such as network 400. Server 330 may be located at a data center, or any other location suitable for providing service to network 400 whereby server 330 may be in one central location or in many different locations in multiple arrangements. Server 330 may comprise a database server such as MySQL® or Maria DB® server. Server 330 may have an attached data storage system storing software applications and data. Server 330 may have a number of modules that provide various functions related to sun visor attachment 100. Modules may be in the form of software or computer programs that interact with the operating system of server 330 whereby data collected in databases as instruction-based expressions of components and/or processes may be processed by one or more processors within server 330 or as well as in conjunction with execution of one or more other computer programs. Modules may be configured to receive commands or requests from sun visor attachment 100, computing device 220, server 330, and outside connected devices over network 400. Server 330 may comprise components, subsystems, and modules to support one or more management services for sun visor attachment 100.

In one or more non-limiting embodiments, network 400 may include a local area network (LAN), such as a company Intranet, a metropolitan area network (MAN), or a wide area network (WAN), such as the Internet or World Wide Web. Network 400 may be a private network or a public network, or a combination thereof. Network 400 may be any type of network known in the art, including a telecommunications network, a wireless network (including Wi-Fi), and a wireline network. Network 400 may include mobile telephone networks utilizing any protocol or protocols used to communicate among mobile digital user computing devices (e.g., computing device 220), such as GSM, GPRS, UMTS, AMPS, TDMA, or CDMA. In one or more non-limiting embodiments, different types of data may be transmitted via network 400 via different protocols. In alternative embodiments, computing devices 220 may act as standalone devices or they may operate as peer machines in a peer-to-peer (or distributed) network environment.

Network 400 may further include a system of terminals, gateways, and routers. Network 400 may employ one or more cellular access technologies including 2nd (2G), 3rd (3G), 4th (4G), 5th (5G), LTE, Global System for Mobile communication (GSM), General Packet Radio Services (GPRS), Enhanced Data GSM Environment (EDGE), and other access technologies that may provide for broader coverage between user computing devices if, for instance, they are in a remote location not accessible by other networks.

User interface 210 on computing device 220 may display statuses for sun visor attachments 100 that are registered or otherwise in communication with computing device 220. For instance, user interface 210 may display information to user 202 logged in to an account that includes for sun visor attachments 100 for three different positions in the vehicle. A status for each sun visor attachment 100 is displayed on a list. In one embodiment, the list may be a dynamic list in which for sun visor attachments 100 are ordered according to the name of the drink.

User interface 210 may have an adjustable timer component for sun visor attachments 100 to operate in synchronization whereby the timer component may enable input from user 202 for electromechanical release mechanism 130 to delay state changes when lowering different lenses. Thus, activation may be delayed for an amount of time by user 202 through user interface 210. The amount of time for the delay may be predetermined, at random, or by the input obtained from user 202 such as based on the amount of time user 202 selects a selectable manual button on user interface 210 to deploy lenses 120. User interface 210 may allow user 202 to deploy lenses 120 only at certain times of the day. For instance, user interface 210 may present to user 202 options to switch the state of electromechanical release mechanism 130 to operate at preprogrammed times, at times determined according to a random pattern, or any other variation. User interface 210 may present one or more clocks that provide an understanding of time of day, day, month, or year, that lenses 120 may be deployed. In one or more embodiments electromechanical release mechanism 130 may be activated by one or more buttons on a surface of the sun visor attachment 100.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical applications, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A sun visor attachment with a main body holding one or more deployable lenses that extend downward to protect one or more eyes of a driver of a vehicle.

2. The sun visor attachment of claim 1, further comprising one or more fasteners configured to fasten to an existing sun visor on the vehicle.

3. The sun visor attachment of claim 1, further comprising one or more guide slots for receiving and guiding the one or more deployable lenses.

4. The sun visor attachment of claim 3, wherein the one or more guide slots are positioned on end caps that are connected to sides of the main body.

5. The sun visor attachment of claim 4, wherein the one or more deployable lenses have protrusions designed to prevent the one or more deployable lenses from completely leaving the one or more guide slots.

6. The sun visor attachment of claim 5, wherein one or more foam inserts are positioned around the one or more deployable lenses inside the main body.

7. The sun visor attachment of claim 6, wherein the one or more deployable lenses have a handle at a bottom for pulling the one or more deployable lenses downward.

8. The sun visor attachment of claim 7, further comprising one or more springs in the one or more guide slots that are biased to move the one or more lenses upward.

9. The sun visor attachment of claim 8, further comprising a latch member for holding the one or more deployable lenses at a position with respect to the one or more guide slots.

10. A sun visor attachment with a main body holding a plurality of lenses that extend downward to protect one or more eyes of a driver of a vehicle.

11. The sun visor attachment of claim 10, further comprising a plurality of guide slots for receiving and guiding the plurality of lenses.

12. The sun visor attachment of claim 11, wherein the plurality of lenses have protrusions designed to prevent the plurality of lenses from completely leaving the plurality of guide slots.

13. The sun visor attachment of claim 10, wherein the one or more lenses are colored coded for benefit provided.

14. The sun visor attachment of claim 10, wherein a first of the plurality of lenses is for blocking total glare from the sun, reduce temperature, and protect vision.

15. The sun visor attachment of claim 14, wherein a second of the plurality of lenses is for providing protected polarized see through for night.

16. The sun visor attachment of claim 15, wherein a third of the plurality of lenses is for providing protected polarized see through for day.

17. A sun visor attachment with one or more lenses that extend downward to protect one or more eyes of a driver of a vehicle and one or more guide slots for receiving and guiding the one or more lenses.

18. The sun visor attachment of claim 17, further comprising an electronic mechanism for controlling movement of the one or more lenses.

19. The sun visor attachment of claim 18, wherein the electronic mechanism is controllable by a separate remote computing device.

20. The sun visor attachment of claim 19, wherein the electronic mechanism is controllable by a computing device on the vehicle.
